(19) United States
(12) Patent Application Publication
(10) Pub. No.: US 2013/0225079 A1
(43) Pub. Date: Aug. 29, 2013

(54) Providing Continued Operation of NFC Mobile Devices and Tags

(71) Applicants: Ayman S. Ashour, Lincoln, NH (US); Michael Kober, Bruckmuehl (DE); Joseph Tassone, Bedford, MA (US); Werner Vogt, Remetschwil (CH)

(72) Inventors: Ayman S. Ashour, Lincoln, NH (US); Michael Kober, Bruckmuehl (DE); Joseph Tassone, Bedford, MA (US); Werner Vogt, Remetschwil (CH)

(73) Assignee: IDENTIVE GROUP, INC., Santa Ana, CA (US)

(21) Appl. No.: 13/405,136

(22) Filed: Feb. 24, 2012

(51) Int. Cl. H04B 7/26; G06K 19/077; G06F 21/00; G06Q 20/20

(52) U.S. Cl. 455/41.2; 705/16; 235/488; 726/3

(57) ABSTRACT

Methods and apparatuses are described herein for providing continued operation of NFC-enabled mobile devices and NFC-enabled tags. The techniques described herein relate to methods and systems using a short-range frequency-enabled tag that can be applied to a short-range frequency-enabled mobile device, resulting in the reduction of interference between the internal short-range frequency circuitry of the mobile device and the short-range frequency receiver and transmitter circuitry of the tag—particularly when communicating with other short-range frequency devices. The techniques provide the advantage of enabling use of both the internal short-range frequency capabilities of the mobile device and the short-range frequency capabilities of the tag, leading to flexible and dynamic applications that leverage both sets of features, as well as access to a wider variety of current and future applications.

### FIELD OF THE INVENTION

The subject matter of this application relates generally to methods and apparatuses for providing continued operation in a combined NFC tag and mobile device environment.

### BACKGROUND OF THE INVENTION

As personal mobile devices have become increasingly common, manufacturers and developers have included an array of features to enable use of the devices beyond the typical telephone, messaging, web browsing and application functionality. One area of recent growth has been the use of mobile devices for information gathering and workflow management. For example, many devices are now equipped with short-range communications interfaces, such as Bluetooth, Wi-Fi, and Near Field Communication (NFC) to enable interaction with a host of additional devices—including physical and logical access control devices, and point-of-purchase and/or electronic wallet devices.

Generally, mobile devices have evolved over time with an ever-increasing variety of models and capabilities. Some types of mobile devices have simple phone functions only, while others provide simple text typing using the telephone keypad with numbers mapped to sets of 3 alpha letters, still others provide a miniaturized keyboard, and/or touch screens, and/or NFC. While technology continues to evolve and use of NFC applications expands, many current and interim models of mobile devices do not include the integrated technology required to support NFC functionality. It may take a substantial amount of time before all mobile phones have inherent NFC.

During these transition years, it is desirable to enable phones and other mobile devices with the capability to be used to emulate certain aspects of NFC functionality. Many Radio Frequency Identification (RFID) tags, labels and stickers have been developed for that purpose that can be affixed to different types of phones or other devices. These vary in size, shape, substrate material, and adhesion characteristics to allow for proper adhesion and operation when attached to the phone or other device body.

As use of such tags becomes more widespread, there is a need to migrate the applications and uses to NFC phones and other mobile devices, as NFC devices become available and users naturally upgrade their units to newer models with NFC functionality. Users would migrate their NFC applications to the new device, taking advantage of the built-in NFC capabilities. However, in practice, such a migration path may not be the easiest or most practical way for every NFC application due to inherent differences in devices and models.

Different device manufacturers and models have different operating characteristics and systems. These operating systems are continuously evolving and have different versions and revision levels. For some applications, new software executables may not be available for all phone models at the same time. Hence there may be cases where it is desirable to continue to operate NFC-like enabled applications on a new NFC phone or device utilizing the separately supplied tag and sticker method for a period of time. For example, a new sticker of the same type as the older sticker could be applied to the new phone for continued operation.

Unfortunately, the nature of NFC technology and RFID technology in general prohibits this due to radio frequency (RF) interference. The NFC phone and the NFC sticker operate at the same fundamental carrier frequency and use the same modulation and demodulation methodology. Therefore, there is a need to isolate the different antenna signals to/from the phone and sticker to prevent the respective antenna signals from interfering with each other.

Interference manifests itself in many undesirable ways. When either device is attempting to communicate with a third NFC device, which is the normal mode of operation, one or the other could interchangeably answer for the other. Typically, both would answer over the same interval of time and interfere, creating a convolved radio response signal causing misreads, reduced range operation, or corrupted data reads and/or responses. In addition, reads intended for the sticker could inadvertently turn on the phone's NFC circuitry, causing it to consume power and drain battery life, when no functions were intended with the phone but only with the sticker. Also, the mobile phone's NFC circuitry could actually detect the presence of the tag adhered to the phone, and attempt to power and read it. Therefore, a tag and sticker technology that can be isolated from the phone's NFC antenna and receiver circuitry would be desirable in the context of NFC mobile devices.

### SUMMARY OF THE INVENTION

Therefore, techniques to isolate a short-range frequency-enabled tag from the short-range frequency circuitry of a mobile device are desirable in this context. The techniques described herein relate to methods and systems using a tag that can be applied to a short-range frequency-enabled mobile device, resulting in the reduction of interference between the internal short-range frequency circuitry of the mobile device and the short-range frequency receiver and transmitter circuitry of the tag. The techniques provide the advantage of enabling use of both the internal short-range frequency capabilities of the mobile device and the short-range frequency capabilities of the tag, leading to flexible and dynamic applications that leverage both sets of features, as well as access to a wider variety of current and future applications.

The invention, in one aspect, features a system for reducing interference between a plurality of short-range frequency communication antenna sources. The system includes a short-range frequency communication-enabled mobile device including a first short-range frequency antenna source. The system includes a short-range frequency communication-enabled tag affixed to the mobile device. The tag includes an adhesion layer, a substrate layer, and a transponder layer including a second short-range frequency communication antenna source. The substrate layer shields radio frequencies emitted by the second antenna source from radio frequencies emitted by the first antenna source to reduce radio frequency interference between the antenna sources.

The invention, in another aspect, features a method for reducing interference between a plurality of short-range frequency communication antenna sources. The method includes affixing, to a short-range frequency communication-enabled mobile device having a first short-range frequency antenna source, a short-range frequency communication-enabled tag. The tag includes an adhesion layer, a substrate layer, and a transponder layer including a second short-range frequency communication antenna source. The method includes emitting, by the first antenna source, a first radio frequency for communicating with a remote device and emitting, by the second antenna source, a second radio frequency for communicating with a remote device. The substrate layer shields the second radio frequency emitted by the second antenna source from the first radio frequency emitted by the first antenna source to reduce radio frequency interference between the antenna sources.

In some embodiments, any of the above aspects can include one or more of the following features. In some embodiments, the system includes a second short-range frequency communication-enabled device in communication with the mobile device. In some embodiments, the second device is a data-encoded tag, a short-range frequency reader device, a point of sale terminal, or another mobile device.

In some embodiments, the second device is a point of sale terminal and the tag stores payment information. The tag is configured to transmit the payment information to the point of sale terminal, and the mobile device is configured to receive, via the first antenna source, a notification from the point of sale terminal that a payment transaction has occurred, retrieve, from a remote computing device, information related to the payment transaction, and display, on the mobile device, the information related to the payment transaction. In some embodiments, the payment information includes credit information, debit information, bank account information, electronic wallet information, gift card information, or any combination thereof. In some embodiments, the information related to the payment transaction includes a purchase receipt, a purchased ticket, a purchased digital media item, an account balance, or any combination thereof.

In some embodiments, the second device is an access point and the tag stores access control information. The tag is configured to transmit the access control information to the access point, and the mobile device is configured to receive, via the first antenna source, a notification from the access point that the access control information has been verified. In some embodiments, verification of the access control information includes comparing the access control information with security information stored in a database. In some embodiments, verification of the access control information includes activating the access point to provide physical access to an area. In some embodiments, verification of the access control information includes activating the access point to transmit secure data to the mobile device.

In some embodiments, the second short-range frequency communication antenna source includes an antenna and a short-range frequency communication semiconductor chip. In some embodiments, the short-range frequency communication-enabled tag is a sticker. In some embodiments, the short-range frequency is radio-frequency identification (RFID) or near-field communication (NFC).

In some embodiments, the substrate layer re-directs radio frequencies emitted by the second antenna source away from radio frequencies emitted by the first antenna source. In some embodiments, the short-range frequency communication-enabled tag including a display layer used for printing on the tag. In some embodiments, the short-range frequency communication-enabled tag stores identification information associated with a user of the mobile device. In some embodiments, the first antenna source is connected to a third antenna source of a second device via a peer-to-peer communication link.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for reducing interference between a plurality of short-range frequency communication antenna sources.

FIG. 2 is a cross-sectional view of a short-range frequency communication-enabled tag with a plurality of layers for providing a radio frequency field to reduce interference with other short-range frequency communication antenna sources.

FIG. 3 is a diagram of electromagnetic radio frequency fields emitted by an NFC tag affixed to a mobile device and electromagnetic radio frequency fields emitted by the mobile device.

FIG. 4 is a diagram showing operation of the system in which radio frequency interference between a plurality of short-range frequency communication antenna sources is reduced.

FIG. 5 is a diagram showing operation of the system in which radio frequency interference between a plurality of short-range frequency communication antenna sources is reduced.

FIG. 6 is a flow diagram of a method for conducting a payment transaction using the system of FIG. 1.

### DETAILED DESCRIPTION

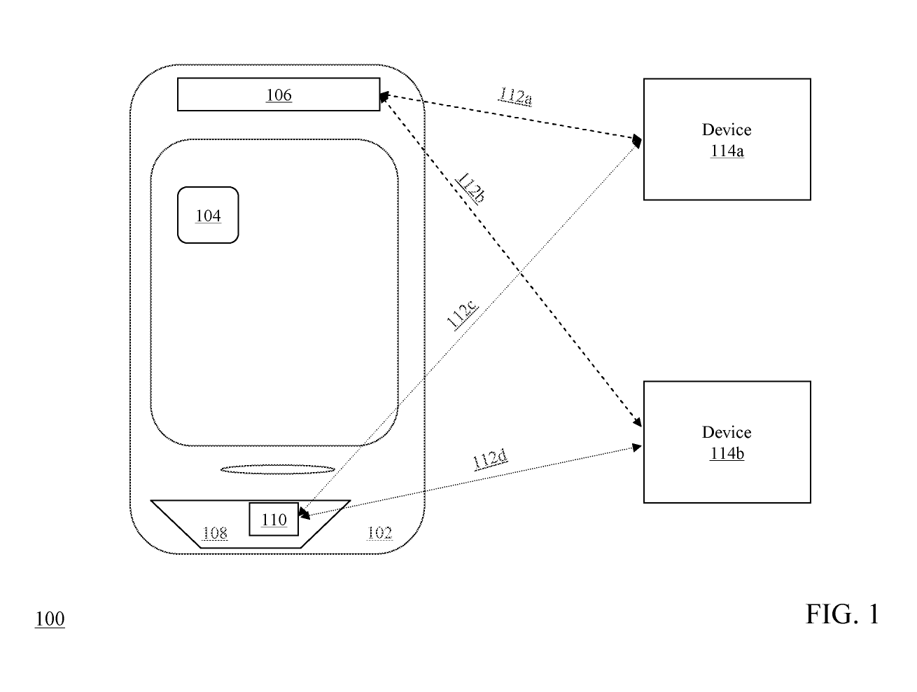

FIG. 1 is a block diagram of a system 100 for reducing interference between a plurality of short-range frequency communication antenna sources. The system 100 includes a mobile computing device 102 having one or more mobile applications (e.g., mobile application 104), a short-range frequency antenna source 106 (e.g., an antenna or similar communications circuitry) integrated into the phone, and a tag 108 affixed externally to the mobile device—the tag having its own embedded short-range frequency antenna source 110. The system 100 also includes communications links 112a and 112b, communicating to devices 114a and 114b, respectively. For example, the mobile computing device 102 communicates with the device 114a via the communications link 112a.

Example mobile computing devices 102 can include, but are not limited to a smart phone (e.g., Apple iPhone®, BlackBerry®, Android™-based device) or other mobile communications device, a tablet computer, an internet appliance, a personal computer, or the like. The mobile device 102 can be configured to include an embedded digital camera apparatus, and a storage module (e.g., flash memory) to hold photographs, video or other information captured with the camera. The mobile device 102 includes network-interface components to enable the user to connect to a communications network, such as the Internet, wireless network (e.g., GPRS, CDMA), or the like. The mobile device 102 includes a processor and operating system to allow execution of mobile applications (e.g., application 104), including an input pad or keys, and a screen for displaying the applications to a user.

The mobile device 102 includes a short-range frequency antenna source 106 (e.g., antenna circuitry) that enables the mobile device 102 to communicate with other devices (e.g., device 114a) that are in proximity to the mobile device 102, using a short-range frequency protocol (e.g., NFC). For example, the mobile device 102 uses the short-range frequency antenna source 106 to communicate with various devices that are external to the mobile device (e.g., devices 114a and 114b) via a communication link (112a and 112b) established over the short-range frequency.

In some embodiments, the short-range frequency antenna source 106 can include a radio-frequency identification (RFID) interface and/or a near-field communication (NFC) interface. The short-range frequency antenna source 106 can comprise a combination of hardware (e.g., an RF receiver, antenna) and software to manage the antenna source 106. The short-range frequency antenna source 106 interacts with other devices (e.g., device 114a, device 114b) that are in proximity to the mobile device 102 and have the capability to communicate with the mobile device 102 via a communication link (e.g., links 112a, 112b) using short-range frequency. The devices 114a, 114b can include, but are not limited to, data-encoded tags, smart cards, proximity access cards, short-range frequency reader devices, and mobile devices (e.g., smart phones, PDAs, tablets). As can be appreciated, other devices capable of communicating via short-range frequency can be used without departing from the spirit or scope of the techniques described herein.

The mobile device 102 also has a tag 108 affixed to the external housing of the device 102. The tag 108 (described in greater detail below) includes a separate short-range frequency antenna source 110 embedded as a layer within the tag. The tag 108 uses the short-range frequency antenna source 110 to communicate with other devices (e.g., devices 114a and 114b) that are in proximity to the tag 108, using a short-range frequency protocol (e.g., NFC). For example, the tag 108 uses the short-range frequency antenna source 110 to communicate with various devices that are external to the mobile device (e.g., devices 114a and 114b) via a communication link (112c and 112d) established over the short-range frequency.

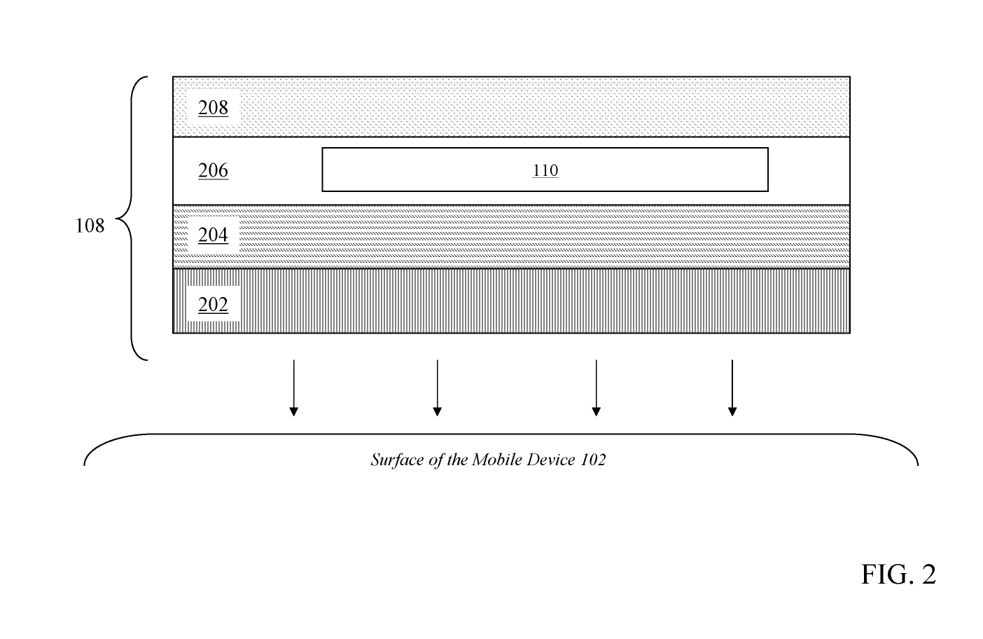

FIG. 2 is a cross-sectional view of a short-range frequency communication-enabled tag (e.g., tag 108) with a plurality of layers for providing a radio frequency field that has reduced interference with other short-range frequency communication antenna sources. In some embodiments, the tag is a sticker.

The tag 108 is constructed of a plurality of layers, arranged in a stack. The layers include an adhesion layer 202, a substrate layer 204, and a transponder layer 206. In some embodiments, the tag includes a display and printing layer 208.

The bottom layer of the tag 108 comprises an adhesion layer 202, used to adhere the tag to a variety of mobile device surface material finishes (e.g., painted metals, aluminums, coated plastics, and the like). Such adhesives are well known in the art and can be permanent or semi-permanent, depending on such factors as the contact surface and materials employed as well as the desired life of the adhesion. Adhesives are typically contact cements, glues, and epoxy of various natures and characteristics. The adhesion layer 201 is usually covered by a removable, protective coated paper or plastic coating (not shown) that is peeled away and removed prior to applying the tag to the desired surface.

The tag 108 also includes a substrate layer 204, comprised of magnetic shielding material. The substrate layer 204 provides a shielding layer between the mobile device 102 and the transponder layer 206 which contains the short-range frequency antenna source 110 of the tag 108. The substrate layer 204 material type, thickness, and magnetic properties are chosen to provide shielding characteristics at a nominal NFC operating frequency (e.g., 13.56 MHz) and field strength range. Material types employed in the substrate layer 204 are usually soft magnetic particles, or other similar material with desired electromagnetic properties at the operating frequency and flux strength. Soft magnetic particles comprise ferrites, the ferrites including: iron, nickel, cobalt, gadolinium, compounds of the garnet group of substances, or alloys, amorphous metals or nano-crystalline structures or any combination thereof.

The tag 108 also includes a transponder layer 206, comprised of a short-range frequency antenna source 110. In some embodiments, the short-range frequency antenna source 110 includes an antenna and RFID semiconductor chip on its own sub-carrier layer. The sub-carrier can be comprised of a variety of materials. For example, the sub-carrier can be comprised of PET (polyester), FR-4 (or any other printed circuit board (PCB) material), PI (polyimide), BT (bismaleimide-triazine), PE (polyethylene), PVC (polyvinylchloride), PC (polycarbonate), Teslin (silica-filled polyethylene), paper and/or other suitable antenna substrate materials. The sub-carrier layer can be outlined in a number of different shapes and geometries to accommodate the size, shape, and geometry of the particular surface location of the mobile device 102 where the tag 108 is affixed. The shape and geometry of the sub-carrier layer, alone or in combination with the location where the tag 108 is affixed, can reduce interference with the mobile device's 102 internal short-range frequency antenna source (e.g., 106 in FIG. 1).

The tag 108 can also include a data storage element (e.g., memory) that contains information which can be read by other devices (e.g., device 114a) able to communicate with the tag 108 via short-range frequency. The information can be related to the specifications and characteristics of the device, related to the user of the device, and/or related to services or products used by the user of the device. As can be appreciated, other types of information can be stored on the tag 108 without departing from the spirit or scope of the techniques described herein.

In addition, the antenna coil size, geometry, and number of coil turns of the short-range frequency antenna source 110 can be adjusted to limit the radio frequency field strength that is generated upon excitation within a predetermined range, thereby further reducing interference with the internal short-range frequency antenna source 106 of the mobile device 102. In determining a particular location on the mobile device 102 to affix the tag 108, the mobile device's short-range frequency antenna source 106 can be located by using the tap point of the device 102. The tap point indicates the preferred location on the device 102 to come in contact with other short-range frequency capable devices for communication. Generally, the tap point is visually identified on the exterior of the device 102.

The tag 108 can be affixed to the mobile device 102 in a different location, preferably an opposite surface as far away from the tap point as feasible. In some embodiments, the tag 108 can also be placed on a perpendicular surface of the mobile device 102. In doing so, the electromagnetic induction and signal strength of the short-range frequency antenna source 110 of the tag 108 is reduced, due to the orthogonal rule of electromagnetic fields generation and induction to electric current flow.

Finally, in some embodiments, the tag 108 includes a printing layer 208 used for graphics printing and aesthetic purposes, such as branding or marketing. In addition, the printing layer 208 can include a thin, often transparent coating layer for protection purposes. The printing layer 208 can be comprised of varying materials and cost, based on the desired quality of finish, printability, color, durability, thickness, and the like. Materials used in the printing layer 208 include paper, PET (polyester), PI (polyimide), PE (polyethylene), PVC (polyvinylchloride), PC (polycarbonate), Teslin (silica-filled polyethylene), and other similar materials.

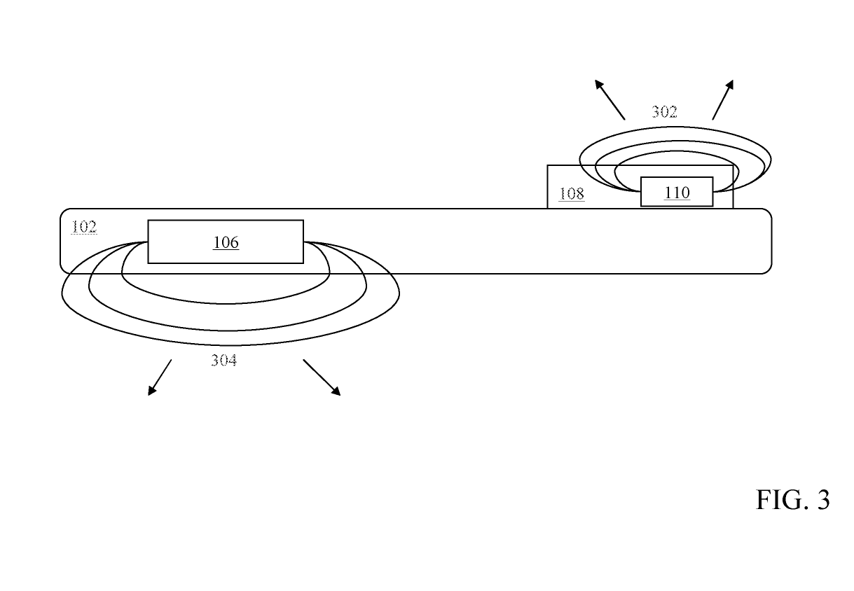

FIG. 3 is a diagram 300 of electromagnetic radio frequency fields 302 emitted by the short-range frequency antenna source 110 of the tag 108 and radio frequency fields 304 emitted by the short-range frequency antenna source 106 of the mobile device 102. The electromagnetic fields 302 and 304, shown in FIG. 3 as waves of flux in typical engineering convention, emanate at the antenna coil and reduce in strength according to the inverse square law. The electromagnetic fields 302 emitted by the short-range frequency antenna source 110 of the tag 108 are also affected by the tag's substrate layer 204 (as shown in FIG. 2), resulting in generally unidirectional waves. As described above, the characteristics of the substrate layer 204 (e.g., the type of material used and its properties, density of the layer, thickness of the layer, and pattern geometry of the layer) affect the amount of shielding and attenuation produced to the electromagnetic field. The characteristics of the substrate layer are described in U.S. Pat. No. 7,053,854, titled “Device for Shielding a Transponder, Method for Producing a Corresponding Shielding and Transponder Provided with Said Shielding,” U.S. patent application Ser. No. 13/218,018, titled “RFID Label with Shielding Element,” and U.S. Patent Application Publication No. 2010/0201596, titled “Apparatus, Method and Use for Screening the Magnetic Field of an RFID Transponder”.

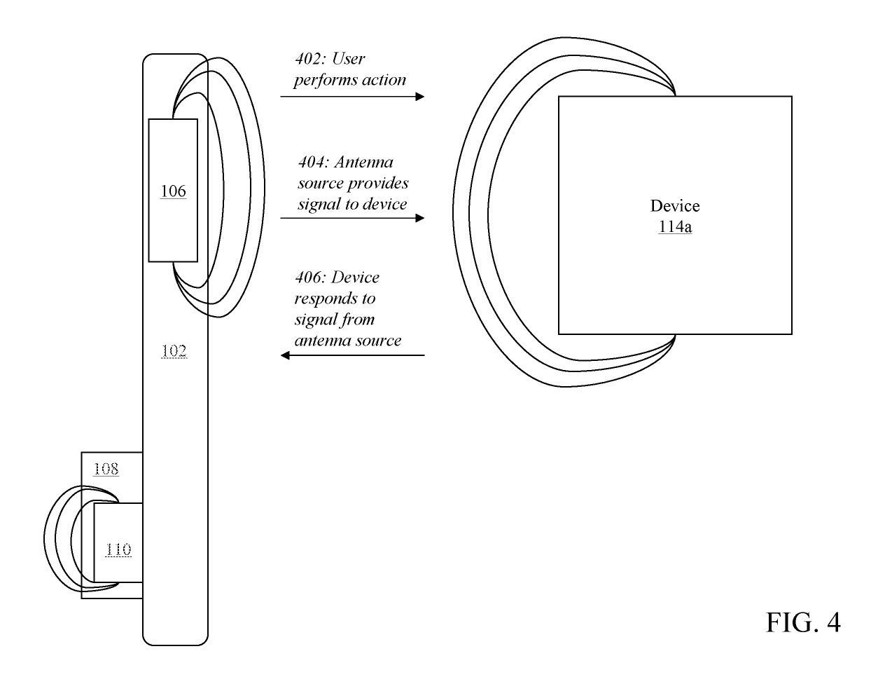

FIG. 4 is a flow diagram 400 showing operation of the system 100 in which radio frequency interference between a plurality of short-range frequency communication antenna sources (e.g., sources 106 and 110) is reduced. To initiate a communication between the short-range frequency antenna source 106 of the mobile device 102 and a remote device (e.g., device 114a), a user of the mobile device performs an action (402) with respect to the remote device 114a. For example, the user can tap the mobile device 102 against the surface of the remote device 114a or wave the mobile device 102 in close proximity to the remote device 114a. The short-range frequency antenna source 106 mobile device 102 provides (404) a short-range frequency signal (e.g., RFID, NFC) that acts to energize the remote device 114a.

Once energized, the remote device 114a responds (406) to the mobile device 102 in a particular manner depending on the mode of the communication. For example, the remote device 114a can respond to the mobile device 102 with data stored in or retrieved by the remote device 114a, when the device 114a is using a card emulator mode. In another example, the remote device 114a can respond to the mobile device 102 with a response protocol to establish a communication link (e.g., 112a) when the device 114a is using a peer-to-peer mode. Such example modes of short-range frequency communication are documented in the literature—see NXP Corp—NFC Tags—“A Technical Introduction, Applications and Products”, Rev. 1.03 December 2011; NXP Near Field Communication (NFC) for handheld devices, and POS terminals PN532, January 2009; NFC Forum—Exchange Format Technical Specification.

As can be appreciated, NFC and RFID technologies are defined for operation in a close proximity environment. Typical operating distances are up to approximately 4 cm (1½ inches). As shown in FIG. 4 and in the fields 304 of FIG. 3, the electromagnetic fields emitted by the short-range frequency antenna source 106 of the mobile device 102 are largely unidirectional, thereby reducing interference with a tag 108 that is located on the opposite surface of the mobile device 102 and which is shielded by the ferromagnetic substrate layer 204 of the tag 108. The substrate layer 204 reduces interference not only between the antenna source 110 and the antenna source 106, but also between the antenna source 110 and the electromagnetic waves emitted by the remote device 114a when the tag 108 is not in use.

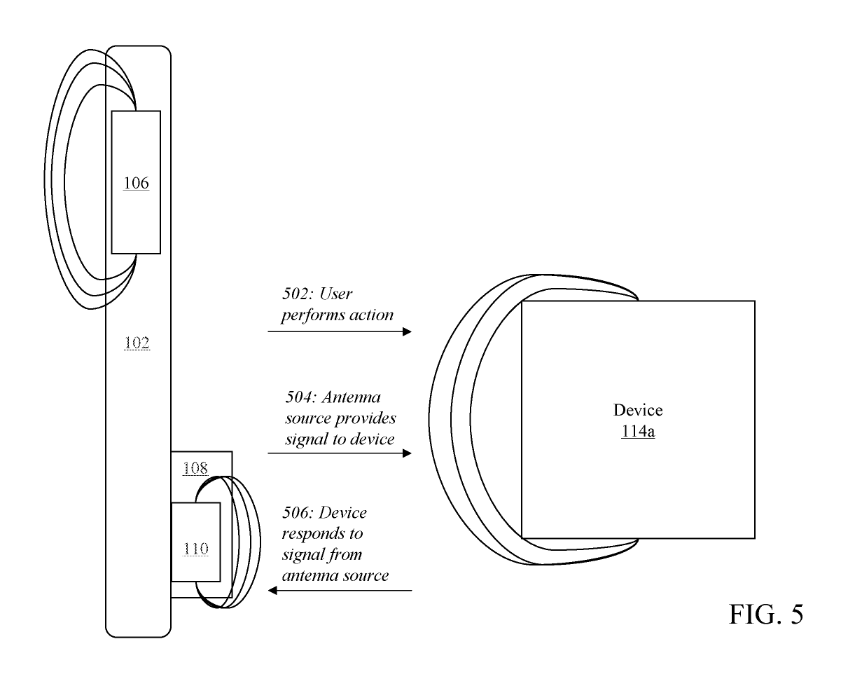

Similarly, as shown in FIG. 5, there is reduced interference between the antenna source 110 of the tag 108 and the antenna source 106 of the mobile device 102 when the tag 108 is active and in communication with a remote device 114a. To initiate a communication between the short-range frequency antenna source 110 of the tag 108 and a remote device (e.g., device 114a), a user of the mobile device having the tag 108 affixed thereon performs an action (502) with respect to the remote device 114a. For example, the user can tap the tag 108 against the surface of the remote device 114a or wave the tag 108 in close proximity to the remote device 114a. The short-range frequency antenna source 110 of the tag 108 provides (504) a short-range frequency signal (e.g., RFID, NFC) that acts to energize the remote device 114a. Once energized, the remote device 114a responds (506) to the tag 108 in a particular manner depending on the mode of the communication. For example, the remote device 114a can read data on the tag 108, when the device 114a is using a card reader mode.

### Example Use Case #1

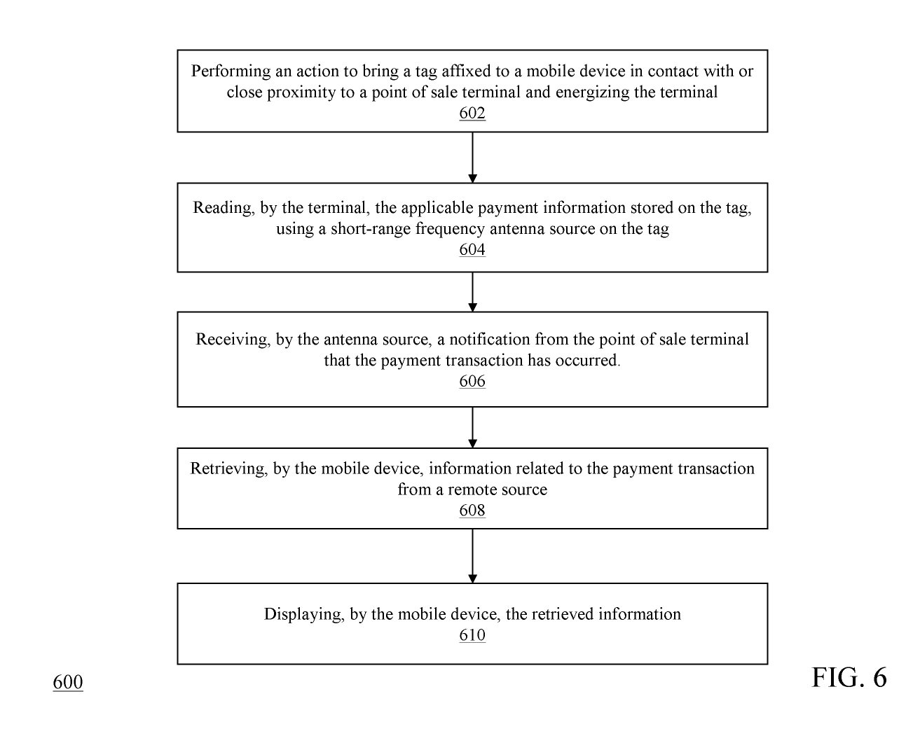

In one example, the techniques described herein can be implemented to conduct a payment transaction. In this example, the device 114a is a point of sale terminal, such as a RFID or NFC reader connected to a cash register or other payment collection device. FIG. 6 is a flow diagram 600 of a method for conducting a payment transaction using the system 100 of FIG. 1. The tag 108 contains payment information associated with the user of the mobile device 102, including but not limited to credit card account data, debit card account data, bank account data, electronic wallet data, gift card account information, rewards points information, and the like. The user performs an action (602) to bring the tag 108 in contact with or close proximity to the point of sale terminal 114a, thereby energizing the terminal 114a.

The terminal 114a communicates with the short-range frequency antenna source 110 on the tag 108 to read (604) the applicable payment information stored on the tag 108. The terminal 114a uses the received payment information to process the payment transaction. In some embodiments, once the payment transaction has been executed, the terminal 114 can then communicate with the antenna source 106 integrated into the mobile device 102. The antenna source 106 receives (606) a notification from the point of sale terminal 114a that the payment transaction has occurred. The notification can also include information related to the transaction, such as the quantity, price, identity of items purchased, identity of seller, date, time, and the like.

Upon receiving the notification, the mobile device 102 retrieves (608) information related to the payment transaction from a remote source (e.g., a remote computing device). The mobile device 102 can use other communications interfaces with which it is equipped (e.g., Wi-Fi, cellular) to communicate with the remote source. The information related to the payment transaction can include, but is not limited to, a purchase receipt, a purchased ticket, a purchased digital media item, and an account balance. The mobile device 102 can then display (610) the retrieved information to the user.

### Other Examples

In some embodiments, the mobile device 102 can be used in conjunction with a smart card or other short-range frequency card to enhance the security provided to the mobile device 102. For example, the short-range frequency antenna source 106 of the mobile device 102 detects a short-range frequency card in proximity to the device 102 The short-range frequency antenna source 106 reads data from the short-range frequency card and, upon validation of the data from the card, the mobile device 102 maintains the activation of the short-range frequency antenna source 106. In cases where the data from the short-range frequency card cannot be validated, the mobile device 102 is configured to deactivate the short-range frequency antenna source 106, thus preventing further use of the antenna source 106 without the required card. In some embodiments, the mobile device 102 can also lock itself or become deactivated if data from the short-range frequency card is unavailable or cannot be verified.

The short-range frequency antenna source 106 can include a card emulator configured to enable the mobile device 102 to communicate with a card reader device (e.g., device 114a). In this manner, the mobile device 102 can act as a replacement for a smart card carried by the user, such that the mobile device 102 is used to access the same types of devices and information as the smartcard.

In some embodiments, the short-range frequency antenna source 106 on the mobile device 102 is used to further enhance the security features of the mobile device. The mobile device uses the short-range frequency antenna source 106 to communicate with another device (e.g., device 114a) by establishing a communication link 112a. In some embodiments, the communication link 112a between the mobile device 102 and the device 114a is a peer-to-peer link. Once the communication link 112a has been established, the mobile device 102 executes a workflow based on data transmitted between the mobile device and the device 114a via the communication link 112a. The workflow can comprise a number of different tasks and/or process steps that are related to security, such as physical access control, logical access control, data access, content sharing, discovering other devices, execution of applications, or transmission of alerts or other messages.

In some embodiments, the system 100 provides a dual system for NFC and NFC-like interactions and transactions. For example, the system 100 provides interactions utilizing the internal NFC capabilities of the mobile device 102. The system 100 also provides interactions utilizing the add-on capabilities of the external tag 108. For the latter, the system 100 provides a bridge and migration path from current mobile devices that are without integrated NFC capabilities, to future mobile devices with integrated NFC capabilities.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, both general and special purpose microprocessors, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computer in communication with a display device, e.g., a CRT (cathode ray tube), plasma, or LCD (liquid crystal display) monitor, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer, laptop computer) with a World Wide Web browser (e.g., Microsoft® Internet Explorer® available from Microsoft Corporation, Mozilla® Firefox available from Mozilla Corporation). Mobile computing device include, for example, a Blackberry®. IP phones include, for example, a Cisco® Unified IP Phone 7985G available from Cisco Systems, Inc, and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein.

What is claimed is:

1. A system for reducing interference between a plurality of short-range frequency communication antenna sources, the system comprising:
a short-range frequency communication-enabled mobile device, the mobile device including a first short-range frequency antenna source;
a short-range frequency communication-enabled tag affixed to the mobile device, the tag comprising:
an adhesion layer;
a substrate layer; and
a transponder layer including a second short-range frequency communication antenna source;
wherein the substrate layer shields radio frequencies emitted by the second antenna source from radio frequencies emitted by the first antenna source to reduce radio frequency interference between the antenna sources.

2. The system of claim 1, further comprising:
a second short-range frequency communication-enabled device in communication with the mobile device.

3. The system of claim 2, wherein the second device is a data-encoded tag, a short-range frequency reader device, a point of sale terminal, or another mobile device.

4. The system of claim 2, wherein the second device is a point of sale terminal and the tag stores payment information,
the tag configured to transmit the payment information to the point of sale terminal; and
the mobile device configured to:
receive, via the first antenna source, a notification from the point of sale terminal that a payment transaction has occurred;
retrieve, from a remote computing device, information related to the payment transaction; and
display, on the mobile device, the information related to the payment transaction.

5. The system of claim 4, wherein the payment information includes credit information, debit information, bank account information, electronic wallet information, gift card information, or any combination thereof.

6. The system of claim 4, wherein the information related to the payment transaction includes a purchase receipt, a purchased ticket, a purchased digital media item, an account balance, or any combination thereof.

7. The system of claim 2, wherein the second device is an access point and the tag stores access control information,
the tag configured to transmit the access control information to the access point; and
the mobile device configured to:
receive, via the first antenna source, a notification from the access point that the access control information has been verified.

8. The system of claim 7, wherein verification of the access control information includes comparing the access control information with security information stored in a database.

9. The system of claim 7, wherein verification of the access control information includes activating the access point to provide physical access to an area.

10. The system of claim 7, wherein verification of the access control information includes activating the access point to transmit secure data to the mobile device.

11. The system of claim 10, wherein the mobile device is further configured to display the secure data.

12. The system of claim 1, wherein the second short-range frequency communication antenna source includes an antenna and a short-range frequency communication semiconductor chip.

13. The system of claim 1, wherein the short-range frequency communication-enabled tag is a sticker.

14. The system of claim 1, wherein the short-range frequency is radio-frequency identification (RFID) or near-field communication (NFC).

15. The system of claim 1, wherein the substrate layer re-directs radio frequencies emitted by the second antenna source away from radio frequencies emitted by the first antenna source.

16. The system of claim 1, the short-range frequency communication-enabled tag including a display layer used for printing on the tag.

17. The system of claim 1, wherein the short-range frequency communication-enabled tag stores identification information associated with a user of the mobile device.

18. The system of claim 1, wherein the first antenna source is connected to a third antenna source of a second device via a peer-to-peer communication link.

19. A method for reducing interference between a plurality of short-range frequency communication antenna sources, the method comprising:
affixing, to a short-range frequency communication-enabled mobile device having a first short-range frequency antenna source, a short-range frequency communication-enabled tag, the tag comprising:
an adhesion layer;
a substrate layer; and
a transponder layer including a second short-range frequency communication antenna source;
emitting, by the first antenna source, a first radio frequency for communicating with a second device;
emitting, by the second antenna source, a second radio frequency for communicating with the second device;
wherein the substrate layer shields the second radio frequency emitted by the second antenna source from the first radio frequency emitted by the first antenna source to reduce radio frequency interference between the antenna sources.

20. The method of claim 19, wherein the second device is a data-encoded tag, a short-range frequency reader device, a point of sale terminal, or another mobile device.

21. The method of claim 20, wherein the second device is a point of sale terminal and the tag stores payment information, the method further comprising:
transmitting, by the tag via the second antenna source, the payment information to the point of sale terminal;
receiving, by the mobile device via the first antenna source, a notification from the point of sale terminal that a payment transaction has occurred;
retrieving, by the mobile device, information related to the payment transaction from a remote computing device; and
displaying, on the mobile device, the information related to the payment transaction.

22. The method of claim 21, wherein the payment information includes credit information, debit information, bank account information, electronic wallet information, gift card information, or any combination thereof.

23. The method of claim 21, wherein the information related to the payment transaction includes a purchase receipt, a purchased ticket, a purchased digital media item, an account balance, or any combination thereof.

24. The method of claim 19, wherein the second device is an access point and the tag stores access control information, the method further comprising:
transmitting, by the tag via the second antenna source, the access control information to the access point;
receive, by the mobile device via the first antenna source, a notification from the access point that the access control information has been verified.

25. The method of claim 24, wherein verification of the access control information includes comparing the access control information with security information stored in a database.

26. The method of claim 24, wherein verification of the access control information includes activating the access point to provide physical access to an area.

27. The method of claim 24, wherein verification of the access control information includes activating the access point to transmit secure data to the mobile device.

28. The method of claim 27, further comprising: displaying, by the mobile device, the secure data.

29. The method of claim 19, wherein the second short-range frequency communication antenna source includes an antenna and a short-range frequency communication semiconductor chip.

30. The method of claim 19, wherein the short-range frequency communication-enabled tag is a sticker.

31. The method of claim 19, wherein the short-range frequency is radio-frequency identification (RFID) or near-field communication (NFC).

32. The method of claim 19, wherein the substrate layer re-directs radio frequencies emitted by the second antenna source away from radio frequencies emitted by the first antenna source.

33. The method of claim 19, the short-range frequency communication-enabled tag including a display layer used for printing on the tag.

34. The method of claim 19, wherein the short-range frequency communication-enabled tag stores identification information associated with a user of the mobile device.

35. The method of claim 19, wherein the first antenna source is connected to a third antenna source of another remote device via a peer-to-peer communication link.
